(19) United States
(12) Patent Application Publication
(10) Pub. No.: US 2026/0134855 A1
(43) Pub. Date: May 14, 2026

(54) SYSTEM FOR AUTOMATIC CONVERSION OF MUSICAL PIECES TO NATURAL TUNING BASED ON CONTEXTUAL ANALYSIS

(71) Applicant: Neeraja Abhyankar, Sunnyvale, CA (US)

(72) Inventor: Neeraja Abhyankar, Sunnyvale, CA (US)

(21) Appl. No.: 19/382,354

(22) Filed: Nov. 7, 2025

Related U.S. Application Data
(60) Provisional application No. 63/718,706, filed on Nov. 10, 2024.

(51) Int. Cl. G10H 1/00

(52) U.S. Cl. CPC G10H 1/0008; G10H 2210/056; G10H 2250/311

(57) ABSTRACT

The present disclosure provides a system for automatic conversion of musical pieces to natural tuning based on contextual analysis, comprising a context input module configured to receive musical context information including note distribution, melodic motifs, harmonic content, temporal dependencies, metadata, and instrument data. The system includes a learning processor configured to process the musical context information using statistical and rule-based models to identify patterns linking musical context with natural tuning relationships, incorporating harmonic relationships as dependencies under a predetermined prime-limit constraining numerical complexity of frequency ratios. The system includes an inference module connected to the context input module and learning processor, configured to convert input notes from equal-tempered tuning to corresponding natural tuning frequencies based on identified patterns and musical context information, generating output comprising natural tuning frequencies expressed as whole number relationships.

### CROSS-REFERENCE TO RELATED APPLICATIONS

This application claims the benefit of U.S. Provisional Patent Application No. 63/718,706, filed on Nov. 10, 2024, which is incorporated by reference herein in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates in general to the field of musical signal processing and tuning systems, and more particularly to a system for automatically inferring natural tuning frequencies, as opposed to equal-tempered tuning, for musical pieces based on contextual analysis using machine learning techniques.

### 2) Description of Related Art

Currently the state of the art includes Standard auto-tune which automatically corrects off-key notes, but strictly within equal-tempered tuning and Manual or custom auto-tune wherein a human operator explicitly selects natural-tone targets or custom pitch adjustments for each note. Neither of which meet the needs of the users.

### 3) Problem Statement

Musical instruments and audio processing systems have traditionally relied on equal-tempered tuning, a standardized system that divides an octave into twelve equally spaced semitones. This tuning system gained widespread adoption due to its mathematical convenience and ability to facilitate transposition between different keys without requiring instrument retuning. Equal temperament enables musicians to play in any key with the same relative intervals, making it particularly suitable for keyboard instruments and ensemble performances.

However, equal-tempered tuning represents a compromise that deviates from the natural acoustic relationships found in physical sound production. When strings, air columns, or vocal chords vibrate, they produce overtone series with frequency ratios that correspond to simple mathematical relationships. For other resonating bodies, the overtones may also be at arbitrary frequency ratios. These natural ratios, known as just intonation or pure tuning, create more consonant harmonic intervals than their equal-tempered approximations.

The use of natural tuning systems presents several technical challenges that have limited their widespread adoption. Unlike equal temperament, natural tuning systems offer multiple frequency options for representing individual notes, with the optimal choice depending on musical context. Additionally, instruments tuned to natural intervals for one key cannot be easily transposed to other keys while maintaining the same harmonic relationships. These limitations have resulted in most modern instruments and digital audio workstations being designed around equal-tempered scales.

Current pitch correction technologies, commonly referred to as auto-tune systems, automatically adjust off-key notes to match predetermined frequency targets. These systems typically default to equal-tempered note frequencies or allow manual specification of custom tuning values. While some advanced audio processing software permits users to define alternative tuning systems, such implementations generally require extensive manual configuration and theoretical knowledge from the operator.

The field of music technology continues to seek improved methods for incorporating natural tuning principles into modern musical production and performance. Such advancements could potentially bridge the gap between the mathematical convenience of equal temperament and the acoustic advantages of just intonation systems.

These and other objects, features, and advantages of the present invention will become more readily apparent from the attached drawings and the detailed description of the preferred embodiments, which follow.

### SUMMARY OF THE INVENTION

Bearing in mind the problems and deficiencies of the prior art, it is therefore an object of the present invention to provide a system for automatic conversion of musical pieces to natural tuning based on contextual analysis.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for automatic conversion of musical pieces to natural tuning based on contextual analysis is provided. The system includes a context input module configured to receive musical context information from at least one musical track, where the musical context information comprises at least one of note distribution over time, melodic motifs, harmonic content, temporal dependencies, metadata, and accompanying instrument data. The system includes a learning processor configured to process the musical context information using at least one of statistical models and rule-based models to identify patterns linking the musical context information with natural tuning relationships. The system includes an inference module operatively connected to the context input module and the learning processor, where the inference module is configured to convert input notes from either equal-tempered tuning or any suboptimal tuning to corresponding natural tuning frequencies based on the identified patterns and the musical context information. The inference module generates output comprising natural tuning frequencies for each input note, where each natural tuning frequency corresponds to frequency ratios expressed as whole number relationships.

According to other aspects of the present disclosure, the system may include one or more of the following features. The learning processor may incorporate harmonic relationships between tones as dependencies in the statistical models. The learning processor may operate under a predetermined prime limit that constrains the numerical complexity of the natural tuning frequency ratios. The context input module may be configured to process musical context information in real-time for live performance applications. The context input module may be configured to process musical context information in batch mode for recorded material processing. The inference module may utilize bidirectional temporal information to refine natural tuning frequency estimates. The system may include an audio processing module configured to convert between audio signals and symbolic musical representations. The inference module may generate probability distributions over candidate natural tuning frequencies for each input note. The natural tuning frequencies may correspond to just intonation tuning systems. The statistical models may comprise at least one of neural networks, decision trees, graph embeddings, transformer architectures, semi-supervised approaches, and sequence-to-sequence models.

According to another aspect of the present disclosure, a method for automatic conversion of musical pieces to natural tuning is provided. The method includes receiving musical input data comprising notes in equal-tempered tuning from at least one musical track. The method includes analyzing musical context information associated with the musical input data, where the musical context information comprises at least one of melodic patterns, harmonic relationships, temporal sequences, and cultural musical characteristics. The method includes applying a trained model to the musical context information to determine contextually appropriate natural tuning frequencies for each note in the musical input data. The method includes generating corrected musical output where each note is converted from equal-tempered tuning to its corresponding natural tuning frequency based on the determined contextually appropriate frequencies.

According to other aspects of the present disclosure, the method may include one or more of the following features. The step of applying the trained model may comprise using machine learning techniques trained on ground truth data comprising at least one of theoretical musical prescriptions and empirical data derived from professional musical performances. The method may include processing multiple musical tracks simultaneously to account for harmonic relationships between tracks. The step of analyzing musical context information may comprise evaluating consonance relationships between simultaneous or successive notes. The method may include updating natural tuning frequency estimates jointly across a context window of multiple notes. The trained model may incorporate physical constraints related to vocal production or auditory perception of consonance. The method may include applying the conversion in real-time during musical performance. The method may include applying the conversion as post-processing to recorded musical material. The natural tuning frequencies may be constrained to frequency ratios having denominators and numerators within predetermined limits. The method may include generating symbolic musical notation specifying the determined natural tuning frequencies.

The foregoing general description of the illustrative embodiments and the following detailed description thereof are merely exemplary aspects of the teachings of this disclosure and are not restrictive.

Still other objects and advantages of the invention will in part be obvious and will in part be apparent from the specification.

The above and other objects, which will be apparent to those skilled in the art, are achieved in the present invention which is directed to a system for automatic conversion of musical pieces to natural tuning based on contextual analysis, comprising:
a. a context input module configured to receive musical context information from at least one musical track, wherein the musical context information comprises at least one of note distribution over time, melodic motifs, harmonic content, temporal dependencies, metadata, and accompanying instrument data;
b. a learning processor configured to process the musical context information using at least one of statistical models and rule-based models to identify patterns linking the musical context information with natural tuning relationships, wherein the learning processor incorporates harmonic relationships between tones as dependencies and operates under a predetermined prime-limit that constrains numerical complexity of natural tuning frequency ratios; and
c. an inference module operatively connected to the context input module and the learning processor, wherein the inference module is configured to convert input notes from equal-tempered tuning to corresponding natural tuning frequencies based on the identified patterns and the musical context information, wherein the inference module generates output comprising natural tuning frequencies for each input note, and wherein each natural tuning frequency corresponds to frequency ratios expressed as whole number relationships, or in general coming from a set of consonant frequencies as per the overtone profiles of the instruments used.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 depicts a Tonnetz diagram illustrating different musical scales and tone relationships, according to aspects of the present disclosure.

FIG. 2 illustrates a network diagram showing relationships between theoretical ground truth, pedagogical theory, and experiential knowledge nodes, according to an embodiment.

FIG. 3 depicts a system diagram showing information flow between a context input module, learning processor, and inference module, according to aspects of the present disclosure.

FIG. 4 illustrates a graph showing pitch correction for musical notes with frequency plotted over time, according to an embodiment.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The term Equal temperament as used in the specification is meant to mean an approximate but convenient tuning system where frequencies of notes are distributed in a geometric series, with 12 notes in an octave, equally spaced on the logarithmic scale.

The terms Just Intonation/Pure Tones/Natural Tones as used in the specification is meant to mean a tuning system where pairs of notes have frequencies perfectly consonant with each other, often achieved when frequency intervals are ratios with whole numbers.

The term Tonnetz Diagram as used in the specification is meant to mean a tool for illustrating the harmonic relationships between tones.

The term “Limit” in tuning as used in the specification is meant to mean the maximum whole number (or a maximum power) that can appear in the computation of the pure tone ratios. The most common such limit is 5, with the resulting tuning system called 5-limit tuning.

The term Musical Comma as used in the specification is meant to mean a small interval that characterizes the difference between two (pure tone) options for a certain note. e.g., the Syntonic wherein the Comma is a ratio of 81/80; tones with frequencies f and 81/80 f appear very close to each other, and map to the same equal temperament note.

The term Indian (Hindustani) Musical notation as used in the specification is meant to mean a solfege notation that encodes the relative pitch of a tone with respect to a tonic (often defined by a drone).

The notes (analogous to Do-Re-Mi-Fa-Sol-La-Ti) are Sa-Re-Ga-Ma-Pa-Dha-Ni

The shorthand as used in the in this disclosure for the 12 notes in an octave (including the flats and sharps) are S-r-R-g-G-m-M-P-d-D-n-N

The term Tonic as used in the specification is meant to mean the fixed reference pitch that defines the tonal center of a piece. This serves as the base (ratio 1:1) for all frequency relationships.

The Term Overtone is used for a resonant frequency (above the fundamental frequency) of a sound. Overtones are not necessarily harmonics.

Prior to a discussion of the preferred embodiment of the invention, it should be understood that while the features and advantages of the invention are illustrated in terms of a system for automatic conversion of musical pieces to natural tuning based on contextual analysis.

The following description sets forth exemplary aspects of the present disclosure. It should be recognized, however, that such description is not intended as a limitation on the scope of the present disclosure. Rather, the description also encompasses combinations and modifications to those exemplary aspects described herein.

The following are U.S. Pat. No. 8,022,286, entitled: REED MUSICAL INSTRUMENT FOR CUSTOMIZABLY PRODUCING MUSICAL SOUNDS, First named inventor: Tejas Pradip Rode, filed 2024 Feb. 1 is incorporated by reference in its entirety.

The following are U.S. Patent application US20250252938 A1, entitled: Sound-object oriented analysis and note-object oriented processing of polyphonic sound recordings, First named inventor: Peter Neubacker, filed 2009 Mar. 5 is incorporated by reference in its entirety.

The following publication by Srijan Deshpande. https://srijan.stck.me/post/5874/The-Electronium-An-Abandoned-Project-2016-17-. is incorporated by reference in its entirety.

The following publication by The Hyper Physics Committee, Georgia State University. http://hyperphysics.phy-astr.gsu.edu/hbase/Music/otone.html is incorporated by reference in its entirety.

Most modern musical instruments as well as commonly used software tools for music are built around a 12-note Equal Tempered scale which is incorporated by reference in its entirety.

The following Wikipedia pages are incorporated by reference in their entirety.

Wikipedia. https://en.wikipedia.org/wiki/Equal_temperament, Wikipedia.
https://en.wikipedia.org/wiki/Just_intonation, Wikipedia.
https://en.wikipedia.org/wiki/Tonnetz, Wikipedia.
https://en.wikipedia.org/wiki/Limit_(music), Wikipedia. https://en.wikipedia.org/wiki/Five-
limit_tuning, Wikipedia. https://en.wikipedia.org/wiki/Comma_(music), Wikipedia.
https://en.wikipedia.org/wiki/Syntonic_comma. Wikipedia.
https://en.wikipedia.org/wiki/Tonic_(music) Wikipedia.
https://en.wikipedia.org/wiki/Overtone.

The following publication by B Chaitanya Deva. “The harmonium and Indian music”. In: Journal of the Indian musicological society 12.3 (1981), p. 45 is incorporated by reference in its entirety.

The following publication by Dr. Vidyadhar Oke. 22 Shrutis and Melodium. Sanskar Prakashan, Mumbai, 2007 is incorporated by reference in its entirety.

The following publication by Dr. Vidyadhar Oke. 22 Shruti Harmonium is incorporated by reference in its entirety.

While this scale is convenient for transposition and manufacturing, it is mathematically and musically imperfect; the frequency ratios between notes deviate from the natural acoustic resonances (most commonly, the simple integer ratios found in open pipe and string overtones), which can lead to subtle but perceptible loss of harmonic purity and consonance.

Natural tuning (also known as Just Intonation, pure tones, or natural tones) instead aligns notes to these consonant ratios.

Despite its advantages, its widespread use has been limited due to a lack of a universal standard, many different frequency options for representing a single note, and the absence of an automated method to decide in real time which of these options is most appropriate (i.e. most consonant or conducive to the intended musical effect) at each moment in a performance or composition.

Western Music operates with a set of constraints pertinent to chords and harmony, which impose additional challenges to the use of Natural Tones. In contrast, Indian Classical Music theory (a melodic tradition based on Raags, i.e., scales or modes enriched with various motifs and embellishments) has long operated in consistence with the Just Intonation paradigm, lending well to melodically-heavy music.

Within such traditions, there exist various informal, often orally transmitted, rules of thumb for using natural tones. These rules suggest that the correct frequency of a tone can, in principle, be inferred from the musical context of the piece, aided by statistical models of music-culture-specific and genre-specific sensibilities.

This invention describes a software (or hardware) system that infers the appropriate natural tones on-the-fly for any musical piece, and generates corrected audio either in real time during performance or asynchronously during post-production.

Direct applications include (1) an auto-tune-type tool for live or pre-recorded music tracks that outputs mathematically accurate, naturally tuned audio, and (2) hardware or firmware modifications that enable previously fixed or equal-tempered instruments to render dynamically inferred natural tones.

Corollary innovations may include self-adjusting instruments that retune based on purely physical mechanisms that react to what is being played, quantitative metrics to evaluate the “musicality” of a piece under various formal definitions, and new approaches for teaching, notating, and visualizing music that incorporate natural tuning as a first principle. This invention will also enable higher-fidelity digital archives and seamless cross-cultural music synthesis.

Examples that illustrate equal-temperament v/s pure tone frequencies for some notes are shown in Table 1.

TABLE 1
Comparison of equal-temperament and pure tone frequency ratios (as multiples of the tonic/root note).

| | Equal-temperament note frequencies | | Pure tone frequencies | |
|---|---|---|---|---|
| | formula | value | some formula choices | some value choices |
| S (tonic) | 1 | 1.0000 | 1 | 1.0000 |
| r (minor second) | 2^{1/12} | 1.0595 | 16/15, 25/24 | 1.0667, 1.0417 |
| R (major second) | 2^{2/12} | 1.1225 | 10/9, 9/8 | 1.1111, 1.1250 |
| g (minor third) | 2^{3/12} | 1.1892 | 6/5, 32/27, 75/64 | 1.2000, 1.1852, 1.1719 |
| G (major third) | 2^{4/12} | 1.2599 | 5/4, 81/64, 32/25 | 1.2500, 1.2656, 1.2800 |
| P (fifth) | 2^{7/12} | 1.4983 | 3/2, 40/27 | 1.5000, 1.4815 |

As shown in Table 1, there is no unique choice of pure tone for any given note name. The multiple choices may seem indistinguishable to an untrained ear, but they have a large impact on the overall musicality of the piece or performance.

A concrete example to illustrate this point is presented in 1. This figure shows a Tonnetz Diagram adapted to Indian solfège, where adjacent tones horizontally (/vertically) have an interval of the fifth (/third) respectively between them.

Bhoop and Deshkar are two Raags in Hindustani Classical music that employ the same scale (Major Pentatonic), yet differ in the mood they create, the characteristic melodic motifs they use, the relative importances assigned to each of the five notes, the region of the octave that compositions are expanded in, and so on. This is one of several examples where musically apt tones are a function of other characteristics of the piece, such as the larger melodic and expressive context.

What, then, affects the choice of tone in a musical context? Here are a few of the several factors that affect this.

Consonance occurs when sounds, not letters, repeat. In the example above, the frequency of the sound waves is what matters, not the different letters (such as “f” vs “ph”) used to produce that sound. When two tones sound simultaneously (as in a harmony) or in quick succession (as in a melody), they sound musically pleasing if they have overlapping overtones in their spectra.

Selecting a tone therefore involves a trade-off; between optimizing local consonance for a certain phrase or chord, versus prioritizing global consistency over the musical piece, i.e., accommodating dissonant chords in order to maintain a constant tuning across the piece.

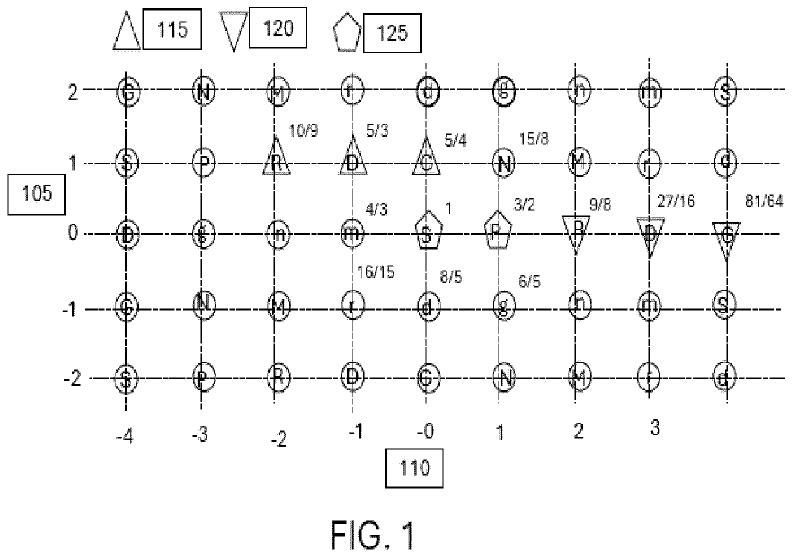

As shown in FIG. 1 which is a Tonnetz diagram graph of Different Tone choices used in different musical contexts for the same notated notes.

Several musical cultures have evolved conditioned on the use of the human voice, pipes, and string instruments-objects that have overtones coinciding with harmonics (i.e., overtone series with frequencies in integer multiples of the fundamental). In such scenarios, consonant tones have in small-integer ratios amongst each other (e.g., 3/2 for the perfect fifth or Pa, 5/4 for the perfect third or Ga, etc.) featuring “small” prime numbers like 3 and 5. Such acoustics underpin historical tuning systems like 3-limit and 5-limit Just Intonation, where the integers in the frequency ratios are restricted to powers of 3 or 5.

Here, it is important to note that while these properties may not be true for all instruments, the analysis done and techniques used for this paradigm may extend with appropriate changes to other musical cultures build on different overtone profiles and acoustic properties to their instruments.

As music-theoretic frameworks get sophisticated, the choice of tones become embedded into cultural sensibilities, informing what “sounds good” to the musician's ear.

For example, in Hindustani Classical Music, where pure tones are heavily used:

Written treatises, studies by contemporary researchers and musical professionals, and oral traditions, some of them with competing and controversial theories, describe circumstances in which certain tones are be chosen over others.

Over time, ornamentations such as glides, oscillations, as well as melodic motif rules have co-evolved-both as expressive devices and as practical means of approaching precise pure tones without explicit calculation.

Even in the absence of explicit pedagogy pertaining to Just Intonation, advanced students of music often reproduce said tones consistently and with high accuracy, reflecting deep implicit learning.

These factors point to the existence of fundamental but partly implicit rules governing pure tone choice.

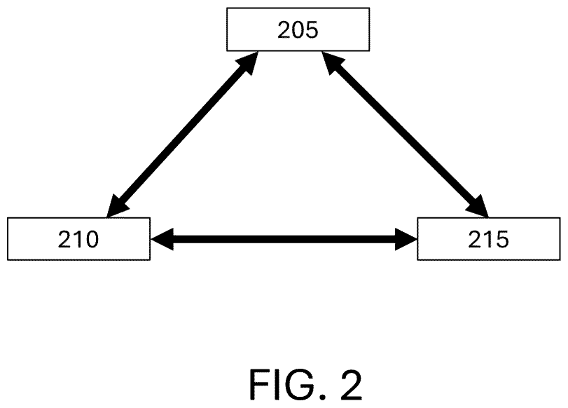

We can formalize these relationships by encoding, statistically or otherwise, the causal links among three interacting layers as shown in FIG. 2:
Item 210 is the pedagogical theory (explicit musical rules and conventions),
Item 215 is the tacit or experiential knowledge (intonation habits, vocalization or playing techniques, ornamentations, etc.), and
Item 205 is the theoretical ground truth of ideal pure tones.

By learning these relationships, a system can generalize to unseen musical pieces and extend to other musical frameworks, cultures, and instruments with different overtone profiles.

Given partial information from any one or two of these, we can deduce information about the third. While this invention is primarily focused on inferring the pure tones for imperfectly tuned but melodically structured pieces, the same machinery can be repurposed for many other scenarios. Potential applications are covered later in this invention.

As of today, the wide use of natural tones is inhibited by the following factors.

### Lack of Transposability:

Instruments tuned to a specific tonic (reference pitch) cannot be easily and precisely transposed to another tonic while preserving the same frequency ratios for all notes. An equal-tempered instrument, in contrast, does not face this challenge; the tuning system is explicitly designed for key changes and transposition without retuning.

### Context-Dependent Tone Choice:

In harmonic traditions that use chords or dense polyphony, performers must choose between locally optimal pure tones (e.g., to make a particular chord perfectly consonant) and globally consistent tones that remain stable across the entire piece. These requirements can conflict, making it impossible to assign a single fixed frequency to each notated pitch.

### Hegemony of Western Equal Temperament:

Due to the above challenges, most widely manufactured instruments in the Western hemisphere are built around the 12-note equal-tempered scale. As a result, even musical cultures that would otherwise more congenitally accommodate natural tuning are effectively constrained to equal temperament when they adopt such instruments.

### Limitations of Software Tools for Music Production:

The majority of mainstream digital audio workstations and music-production environments provide only basic support, if any, for alternative tuning systems. Changing the tuning in such an environment is often cumbersome and results in the loss of nuances on pitch dynamics. This limits the ability to create, edit, or distribute music that relies on dynamically inferred just-intoned pitches.

### Sparse and Inconsistent Documentation:

Research and systematic development of natural-tuning practices adapted to the age of technology, especially within melodic traditions of the global south, remain limited. Where documentation exists, it is often fragmentary, not mathematically rigorous, or disputed, making it difficult to codify culturally established but largely oral knowledge of appropriate pure-tone usage.

The goal of the invention is to infer the correct natural (pure) tone values for each notated note in an entire musical piece (or some subset of it), given a possibly imperfectly tuned input.

In the symbolic space, the crux of the Inference Module (as manifested in any application) of this system can be formulated as follows:

The input is a continuous-time process that takes discrete values among equal-tempered (approximate) notes, and our output is the same process taking on natural (exact) tone values.

| | |
|---|---|
| Input: | xᵢ(t) ∈ S^{K}, |
| | where S = set of approximate notes from the equal tempered |

or otherwise imperfect tuning,

| | |
|---|---|
| Context: | c ∈ C, |

where C is optional, application-dependent metadata,

| | |
|---|---|
| Output: | yᵢ(t) ∈ T^{K}, |
| | where T = set of exact notes / pure tones, |
| | K = number of octaves |
| | spanned by the track, |
| | t = time (continuous), |
| | i = track index (allowing multiple tracks or |
| | overtones or chord layers). |

Each yᵢ(t) is chosen so that its projection (i.e., closest approximation) onto the tuning S^{K} is the observed xᵢ(t).

Such a function can be realized either as a deterministic algorithm or as a machine learning model/neural network trained on human-labelled or auto-labelled ground truth.

In addition, the system may include functions that map the audio signal to symbolic space and vice versa.

```
x^{~}(t) → {xᵢ(t)}ᵢ
{yᵢ(t)}ᵢ → y^{~}(t)
where i = track index
  x^{~}, y^{~} ∈ R
    ∀ t
```

Notable features enabled by this system include:

Flexible temporal inference:

The formulation allows for information from time t′<t to influence the output at time t for real-time tone inference/correction applications; and also permits future information (t′>t) to refine estimates in batch or editing mode when operating on recorded material.

Joint context updates with Transformer-like architectures:

Similar to transformers, this formulation allows for jointly updating the estimates of the correct tones (i.e., probabilities assigned to tone options) over a given context window.

Physical and perceptual priors:

The system is amenable to baking in prior knowledge such as
a. physical rules or physiological constraints of vocal production (e.g., the ease/difficulty of a human's vocal chords or an instrument to produce a certain sound or sound transition) and/or
b. auditory perception (e.g., persistence effects while transitioning from one sound to another consonant one) to be encoded into the algorithm's architecture or via pre-training, before learning any statistical relationships.

Machine-learning options: The learning module may employ techniques including but not limited to:
a. Graph Embeddings, belief propagation (in the harmonic space)
b. Transformers, LSTMs/GRUs, or any sequence-to-token or sequence-to-sequence modules in the temporal space
c. Classifiers over path embeddings, contrastive learning, or metric learning techniques over the harmonic frequency space.
d. Semi-supervised methods that can operate on data with no ground truth labels of pure tone choices, to update, enhance, and refine the learnt relationships between various features of a musical piece. These are semi-supervised learning methods that make limited use of ground truth labels and refine themselves over unlabeled data.

Hardware implementations: The formulation above may just as easily drive hardware devices.

A set of strings or membranes could respond to past overtone content (t′<t) and may have certain modes excited that mechanically bias the vibrations at time t toward consonant ratios.

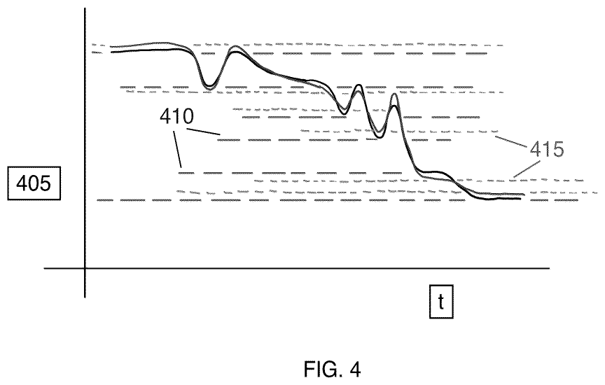

Fine-grained signal correction: As illustrated in FIG. 4, the correction from an imperfect tone to a pure tone can apply not only to stable sustained notes but also to notes that feature as a part of pitch oscillations, inflection points in glides, and other embellishments. Similarly, the corrections can be applied to specific overtones within a complex spectrum.

The system unlocks the following capabilities that are not available with current tools. While the implementations of these may involve combining existing technologies with this invention, the resulting applications themselves are novel.

Accurate symbolic transcription: Automatic creation of music scores that specify the intended natural (just-intoned) frequencies for every note in a piece, rather than only equal-tempered approximations.

Post-production auto-tuning to natural tones: Software that corrects recordings made by amateur performers or on equal-tempered instruments so that each note is adjusted to its contextually appropriate pure tone.

Real-time auto-tuning to natural tones: Live-processing systems that apply the above corrections during a performance or broadcast, allowing singers or instrumentalists to sound musically coherent instantly.

Ear-training and learning tools: Interactive applications that train students to perceive and reproduce just-intoned pitches with precision, helping them internalize natural tuning in the context of other tacit knowledge in the musical framework/tradition, through guided feedback.

Self-retuning instruments: Hardware designs (string, wind, or electronic) capable of dynamically adjusting their tuning in real time according to the evolving musical context, using the invention's inference module as their control logic.

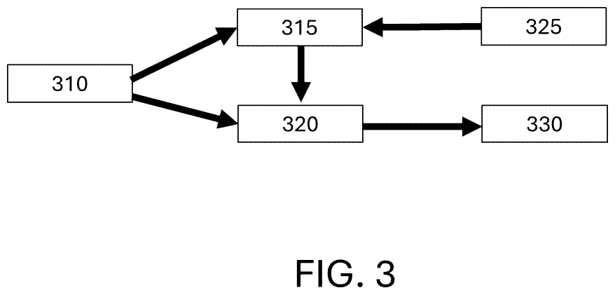

Referring to FIG. 3, a system for automatic conversion of musical pieces from equal-tempered tuning to natural tuning based on contextual analysis comprises a context input module 310, a learning processor 315, and an inference module 320 that work together to determine contextually appropriate natural tuning frequencies. The system addresses the challenge of selecting pure tone frequencies from multiple available options by analyzing musical context including melodic patterns, harmonic relationships, and temporal sequences.

The context input module 310 receives various forms of musical context information that serve as input to the system. The context input module 310 includes long-range context such as note distribution and emphasis over time. The context input module 310 includes medium or short-range context such as melodic motifs, chords, and ornamentation including glides or vibrato. The context input module 310 includes timbre information as part of the musical context. The context input module 310 includes temporal dependence that is causal for real-time inference or bidirectional for dependence on the entire piece or future time steps.

The context input module 310 includes other metadata such as lyrics, scale, or mood. The context input module 310 includes information from other accompanying instruments, tracks, or vocals. The context input module 310 represents information as raw signal features, symbolic transcripts, or neural embeddings. The context input module 310 processes multiple input tracks or harmony layers or chord layers simultaneously.

With continued reference to FIG. 3, the learning processor 315 receives input from both the context input module 310 and ground truth data 325. The learning processor 315 finds patterns linking musical context with ground truth labelled data through statistical or rule-based approaches. The learning processor 315 is implemented as a statistical model or a rule-based model, including neural networks or decision trees.

The learning processor 315 incorporates harmonic relationships between tones as dependencies within the model architecture. The learning processor 315 employs graph embeddings or belief propagation in the harmonic space.

The learning processor 315 employs transformers, LSTMs, or GRUs as sequence-to-token or sequence-to-sequence modules in the temporal space.

The learning processor 315 employs classifiers over path embeddings, contrastive learning, or metric learning techniques over the harmonic x frequency space.

The learning processor 315 operates on data with no ground truth labels on pure tone choices to find and refine causal links or correlations among various factors from the context 310 via semi-supervised (or even unsupervised) optimization of a learnt (or constructed) objective function.

The learning processor 315 operates under a certain prime-limit or odd-limit that caps the tones' numerical complexities.

The ground truth data 325 provides training information for the learning processor 315. The ground truth data 325 includes theoretical ideals based on tradition-specific prescription. The ground truth data 325 includes empirical targets derived from signal analyses of audio by professionals. The system is trained on human-labelled ground truth data. The system is trained on auto-labelled ground truth data.

As further shown in FIG. 3, the inference module 320 receives processed information from the learning processor 315 and context information from the context input module 310. The inference module 320 predicts or assigns probabilities to candidate pure tone choices for each note in the musical piece. The inference module 320 maps predictions to symbolic space, spectral space, or full audio signals. The inference module 320 generates a corrected signal output 330 based on the processed inputs.

The corrected signal output 330 represents the final output of the system. The corrected signal output 330 is in audio form, symbolic form, or both, optionally with postprocessing. The system includes functions that map audio signal to symbolic space. The system includes functions that map symbolic space to audio signal.

The system allows for information from past time steps to influence the output at current time for real-time tone inference applications. The system permits future information to refine estimates in batch or editing mode when operating on recorded material. The system allows for jointly updating estimates of correct tones over a given context window similar to transformer architectures. The system allows for encoding priors guided by physical rules such as vocal chord capabilities and auditory perception constraints.

Referring to FIG. 2, the system operates based on causal links among three interacting layers represented by a theoretical ground truth node 205, a pedagogical theory node 210, and an experiential knowledge node 215. The theoretical ground truth node 205 represents ideal pure tones for musical pieces. The pedagogical theory node 210 represents explicit musical rules and conventions. The experiential knowledge node 215 represents tacit or experiential knowledge including intonation habits, vocalization or playing techniques, and ornamentations.

Referring to FIG. 1, different tone choices used in musical contexts are illustrated through a Tonnetz diagram graph. The diagram includes a vertical power scale 105 representing powers of 5 (i.e., representing perfect thirds or a frequency satio of 5/4 as one goes up the scale). It includes a horizontal power scale 110 representing powers of 3 (i.e., representing perfect fifths or a frequency ratio of 3/2 as once goes right on the scale). In other words, adjacent tones horizontally and vertically have intervals of the fifth and third respectively between them. In characterizing frequency ratios, powers of 2 are ignored (since they correspond to octave shifts and hence the same tone in another octave).

The diagram shows an exclusive bhoop sub-scale 115, an exclusive deshkar sub-scale 120, and an intersection sub-scale 125 that contains elements present in both bhoop and deshkar scales. Elements in the sub-scales 115 and 120 correspond to the same equal temperament notes, however manifest as different natural tones in Raags bhoop and deshkar, respectively. Therefore, one can summarize that the scale 125 from FIG. 1 is not a “hybrid scale”, rather it denotes tones appearing in both scales. Tones in scale 115 and 120 are alternatives of each other, and are chosen together based on which total set of 5 tones suits the melodic pattern.

Referring to FIG. 4, the correction from imperfect tone to pure tone applies to stable sustained notes as well as notes that feature as part of pitch oscillations, inflection points in glides, and other embellishments. The figure shows a frequency axis 405 representing fundamental frequency in Hz, with an equal tempered line 410 and a pure tone line 415 demonstrating pitch correction over time.

The corrections are applied to specific overtones within a complex spectrum. The pure tone line 415 shows how the system adjusts frequencies to achieve natural tuning while the equal tempered line 410 represents the original imperfect tuning. The system processes these corrections in real-time or during post-processing depending on the application requirements.

The system architecture operates through a coordinated interaction between multiple components that process musical information to achieve automatic conversion from equal-tempered tuning to natural tuning. The context input module 310 serves as the primary interface for receiving various forms of musical context information which serves as the input to both the learning processor 315 (at the time of training/building the model) and the inference module 320 (at the time of application).

The information flow begins with the context input module 310 collecting musical context data in any among multiple representation formats. Raw signal features capture the acoustic properties of the input audio directly from the waveform. Symbolic transcripts represent the musical information in notation form with discrete note values and timing information. Neural embeddings provide compressed representations of musical features learned through deep learning architectures. These different representation formats allow the system to process musical information at various levels of abstraction.

The learning processor 315 receives input from both the context input module 310 and the ground truth data 325 to establish relationships between musical context and appropriate pure tone selections. The ground truth data 325 provides training examples that include theoretical ideals based on tradition-specific prescription and/or empirical targets derived from signal analyses of audio by professionals, and/or targets inferred from A/B experiments run for understanding user preferences from various forms of user feedback. The learning processor 315 analyzes these relationships to identify patterns that link contextual musical information with correct natural tuning choices.

The mathematical formulation of the system at the application/inference time defines the input as xᵢt)∈S^{K}, where S represents the set of approximate notes from the imperfect or equal-tempered tuning system. The output is formulated as yᵢ(t)∈T^{K}, where T represents the set of exact pure tones or natural frequencies. The parameter K represents the number of octaves spanned by the musical track, t represents continuous time, and i represents the track index allowing for processing of multiple simultaneous tracks or overtones or harmony layers.

The system includes mapping functions that convert between audio and symbolic representations. The audio-to-symbolic mapping function is expressed as x\tilde{ }(t)→{xᵢ(t)}ᵢ, where x\tilde{ } represents the raw audio signal and {xᵢ(t)}ᵢ represents the symbolic representation across multiple tracks. The symbolic-to-audio mapping function is expressed as {yᵢ(t)}ᵢ→y\tilde{ }(t), where {yᵢ(t)ᵢ}; represents the corrected symbolic output and y\tilde{ }(t) represents the final audio output. Both x\tilde{ } and y\tilde{ } belong to the real number space [symbol] for all values of t.

The inference module 320 processes the learned patterns from the learning processor 315 along with current context information from the context input module 310 to generate predictions for appropriate pure tone selections. The inference module 320 assigns probabilities to candidate pure tone choices for each note based on the contextual analysis. The inference module 320 maps these predictions to different output formats including symbolic space for notation applications, spectral space for frequency domain processing, or full audio signals for direct playback.

The corrected signal output 330 represents the final result of the system processing and is generated in audio form, spectral form, symbolic form, or multiple formats depending on the application requirements. Post-processing operations are applied to the corrected signal output 330 to refine the results and ensure compatibility with downstream applications. The system processes multiple input tracks or harmony layers or chord layers simultaneously, allowing for complex musical arrangements to be converted while maintaining harmonic relationships between different instrumental parts.

The system architecture supports both real-time processing and batch processing modes. Information from past time steps influences the output at current time for real-time tone inference applications, enabling live performance correction. Future information refines estimates in batch or editing mode when operating on recorded material, allowing for more accurate corrections when the complete musical context is available. The system may jointly updates estimates of correct tones over a given context window similar to transformer architectures, enabling sophisticated contextual analysis across extended musical passages.

The learning processor 315 is implemented as either a statistical model or a rule-based model to establish relationships between musical context and appropriate pure tone selections. Neural network architectures serve as statistical models within the learning processor 315, utilizing deep learning techniques to identify complex patterns in musical data. Decision tree implementations provide rule-based approaches within the learning processor 315, creating hierarchical decision structures based on musical context features. The learning processor 315 may interpolate between both statistical and rule-based approaches to leverage the strengths of each methodology in different musical scenarios.

The learning processor 315 incorporates harmonic relationships between tones as dependencies within the model architecture through explicit encoding of frequency ratio relationships. Harmonic dependencies are represented as graph structures where nodes correspond to individual tones and edges represent consonant frequency ratios. The learning processor 315 encodes these harmonic relationships using adjacency matrices that capture the mathematical relationships between pure tone frequencies. Consonant intervals such as perfect fifths and major thirds can be explicitly modeled as strong dependencies within the learning processor 315 architecture.

The learning processor 315 operates under a prime-limit or odd-limit constraint that caps the numerical complexity of tone ratios to ensure practical implementation and perceptual relevance. Prime-limit constraints restrict the frequency ratios to products of prime numbers up to a specified maximum value, such as 5-limit tuning where ratios contain only powers of 2, 3, and 5. Odd-limit constraints restrict the largest odd number that appears in the reduced form of frequency ratios. The learning processor 315 applies these constraints during training to focus on musically relevant pure tone relationships while avoiding overly complex ratios that provide diminishing perceptual benefits. Equivalent complexity limits may be applied to nonstandard overtone profiles as well.

Graph embeddings within the learning processor 315 represent tones as vectors in a continuous space where harmonic relationships correspond to geometric relationships between vectors. The learning processor 315 employs belief propagation algorithms in the harmonic space to propagate probability information between harmonically related tones. Belief propagation enables the learning processor 315 to update tone probability estimates based on the harmonic context of surrounding notes. Graph neural networks within the learning processor 315 process these harmonic relationships to learn complex dependencies between tones across different musical contexts.

Transformer architectures within the learning processor 315 process temporal sequences of musical notes using self-attention mechanisms to capture long-range dependencies. The learning processor 315 employs LSTM networks to model sequential dependencies in musical passages where the hidden state captures information about previous musical context. GRU implementations within the learning processor 315 provide computationally efficient alternatives to LSTM networks while maintaining the ability to model temporal dependencies. Sequence-to-token modules within the learning processor 315 process entire musical phrases to predict individual tone selections, while sequence-to-sequence modules generate complete corrected musical sequences.

The learning processor 315 employs classifiers over path embeddings to categorize musical passages based on their harmonic progression patterns. Contrastive learning techniques within the learning processor 315 learn representations where harmonically consonant tone combinations are embedded closer together than dissonant combinations. Metric learning approaches within the learning processor 315 learn distance functions in the harmonic frequency space that reflect perceptual similarity between different tone combinations. These techniques enable the learning processor 315 to generalize from training examples to new musical contexts with similar harmonic characteristics.

The training process for the learning processor 315 utilizes human-labelled ground truth data where expert musicians provide correct pure tone selections for musical passages. Human labeling involves professional musicians analyzing musical pieces and specifying the contextually appropriate natural frequencies for each note based on harmonic and melodic considerations. Auto-labelled ground truth data is generated through algorithmic analysis of professionally recorded performances where pure tone frequencies are extracted through spectral analysis techniques. Auto-labelled ground truth data may also be gathered on-the-fly in a reinforcement learning formulation, where multiple tone choices are applied for multiple random subsets of users and a preference is inferred if statistically significant. The learning processor 315 learns from multiple types of ground truth data to capture both theoretical knowledge and practical performance practices.

Referring to FIG. 2, the learning processor 315 integrates information from the theoretical ground truth node 205, pedagogical theory node 210, and experiential knowledge node 215 during the training process. Theoretical ideals based on tradition-specific prescriptions provide the learning processor 315 with formal rules about appropriate tone selections in different musical contexts. These theoretical ideals include classical music theory principles, just intonation theory, and culture-specific tuning practices. Empirical targets derived from signal analyses of professional audio recordings provide the learning processor 315 with practical examples of how expert performers actually implement natural tuning in real musical performances. The quality of such recordings/performances may be assigned a weight based on user engagement or feedback signals gathered from streaming platforms/apps.

The learning processor 315 processes training data through multiple epochs where model parameters are iteratively updated to minimize prediction errors on the ground truth data. Backpropagation algorithms within neural network implementations of the learning processor 315 compute gradients and update weights to improve tone prediction accuracy. Cross-validation techniques ensure that the learning processor 315 generalizes well to unseen musical data rather than overfitting to the training examples. Regularization techniques within the learning processor 315 prevent overfitting by constraining model complexity and encouraging simpler solutions that generalize better to new musical contexts.

The learning processor 315 encodes priors guided by physical rules such as vocal chord capabilities and auditory perception constraints into the model architecture. Vocal chord constraints limit the rate of frequency change that the learning processor 315 considers feasible for vocal performances. Auditory perception constraints based on psychoacoustic research inform the learning processor 315 about which frequency differences are perceptually significant to human listeners. These physical and perceptual priors serve as baseline knowledge that guides the learning process even before statistical patterns are learned from training data.

The context input module 310 processes temporal dependencies through two distinct operational modes that accommodate different application requirements and processing constraints. Causal processing within the context input module 310 enables real-time inference applications where information from past time steps influences the output at current time without access to future musical information. The context input module 310 maintains a temporal buffer that stores previous musical context including note sequences, harmonic progressions, and rhythmic patterns to inform current tone selection decisions. This causal processing approach ensures that the system operates with minimal latency during live performance applications where future musical information is unavailable.

Bidirectional processing within the context input module 310 enables batch or editing mode operations where future information refines estimates for more accurate tone selection. The context input module 310 analyzes complete musical passages in bidirectional mode, allowing both preceding and succeeding musical context to influence tone selection at any given time point. This bidirectional analysis enables the context input module 310 to resolve ambiguous tone selections by considering the complete harmonic and melodic trajectory of the musical piece. The context input module 310 switches between causal and bidirectional processing modes based on application requirements and available computational resources.

In addition, the context input module 310 may contain static song-level components from the metadata which do not vary with time.

With continued reference to FIG. 3, the context input module 310 implements joint updating of tone estimates over a context window through attention mechanisms similar to transformer architectures. The context input module 310 divides musical input into overlapping context windows where each window contains a sequence of notes with their associated temporal and harmonic information. Self-attention mechanisms within the context input module 310 compute relationships between all notes within each context window, enabling simultaneous updating of tone probability estimates across the entire window. The context input module 310 applies multi-head attention to capture different types of musical relationships including melodic contour, harmonic progression, and rhythmic patterns within each context window.

The context input module 310 processes long-range context through hierarchical attention mechanisms that capture note distribution and emphasis patterns across extended musical passages. Long-range dependencies within the context input module 310 include tonal center establishment, modulation patterns, and recurring melodic themes that influence tone selection across large temporal spans. The context input module 310 maintains separate attention heads for different temporal scales, with some heads focusing on immediate note-to-note relationships while others capture phrase-level and section-level musical structures. This hierarchical processing enables the context input module 310 to balance local harmonic optimization with global musical coherence.

Medium-range and short-range context processing within the context input module 310 focuses on melodic motifs, chord progressions, and ornamental elements that directly influence tone selection decisions. The context input module 310 identifies melodic motifs through pattern matching algorithms that recognize recurring note sequences and their associated pure tone selections. Chord progression analysis within the context input module 310 determines harmonic context by identifying simultaneous note combinations and their implied harmonic functions. Ornamentation processing within the context input module 310 handles glides, vibrato, and other expressive elements by analyzing their spectral characteristics and temporal evolution patterns.

Referring to FIG. 4, the context input module 310 processes ornamentation including glides and vibrato by analyzing the continuous frequency trajectory represented by the pure tone line 415 as it deviates from the equal tempered line 410. The context input module 310 extracts ornamental features including glide rate, vibrato frequency, and amplitude modulation characteristics from the input audio signal. These ornamental features inform tone selection by indicating the performer's expressive intent and the musical style being employed. The context input module 310 correlates ornamental patterns with appropriate pure tone selections based on training data that captures how expert performers use ornamentation in different musical contexts.

Timbre information processing within the context input module 310 involves spectral analysis of harmonic content, formant characteristics, and temporal envelope properties of musical sounds. The context input module 310 extracts timbral features through Fourier analysis, cepstral analysis, and other spectral processing techniques that characterize the harmonic structure of input sounds. Timbral analysis within the context input module 310 influences tone selection by identifying instrument types, playing techniques, and acoustic characteristics that suggest appropriate pure tone choices. The context input module 310 correlates timbral features with cultural and stylistic preferences for pure tone selection based on training data from different musical traditions.

The context input module 310 processes metadata including lyrics, scale information, and mood indicators to provide additional context for tone selection decisions. Lyrical content analysis within the context input module 310 identifies emotional themes and cultural references that influence appropriate tuning choices. Scale identification within the context input module 310 determines the underlying modal structure of musical passages, which constrains the set of appropriate pure tone options. Mood analysis within the context input module 310 correlates emotional characteristics with tuning preferences based on psychoacoustic research and cultural associations between specific frequency ratios and emotional responses.

Multi-track processing within the context input module 310 handles information from accompanying instruments, tracks, and vocals through parallel analysis channels that maintain harmonic relationships between different musical parts. The context input module 310 analyzes harmonic interactions between simultaneous musical lines to ensure that pure tone selections maintain consonant relationships across all tracks. Cross-track correlation analysis within the context input module 310 identifies harmonic progressions and voice leading patterns that constrain tone selection choices. The context input module 310 prioritizes harmonic consistency across tracks while accommodating individual expressive characteristics of each musical part.

As further shown in FIG. 3, the context input module 310 represents musical information through multiple encoding formats including raw signal features, symbolic transcripts, and neural embeddings that capture different aspects of musical content. Raw signal feature extraction within the context input module 310 processes audio waveforms directly through time-frequency analysis, spectral feature computation, and temporal envelope extraction. Symbolic transcript processing within the context input module 310 handles discrete musical notation including note names, durations, dynamics, and articulation markings. Neural embedding generation within the context input module 310 creates compressed representations of musical features through deep learning architectures trained on large musical datasets.

The context input module 310 encodes physical and physiological priors guided by vocal chord capabilities through biomechanical constraints that limit feasible frequency transitions and sustained tone characteristics. Vocal chord modeling within the context input module 310 incorporates physiological limits on fundamental frequency range, vibrato characteristics, and glide rates based on human vocal production research. The context input module 310 applies these vocal constraints as soft penalties during tone selection, favoring pure tone choices that align with natural vocal production capabilities. Breathing pattern constraints within the context input module 310 influence phrase-level tone selection by considering natural breath support limitations and their impact on sustained tone stability.

Auditory perception constraints within the context input module 310 incorporate psychoacoustic research findings about frequency discrimination thresholds, consonance perception, and temporal masking effects. The context input module 310 encodes just-noticeable difference thresholds for frequency perception, ensuring that pure tone corrections exceed perceptual significance thresholds. Consonance modeling within the context input module 310 incorporates roughness calculations, harmonic coincidence detection, and cultural conditioning effects that influence perceived harmonic stability. Temporal masking considerations within the context input module 310 account for how preceding and succeeding sounds influence the perception of current tones.

Referring to FIG. 2, the context input module 310 integrates priors from the theoretical ground truth node 205, pedagogical theory node 210, and experiential knowledge node 215 through weighted combination schemes that balance different sources of musical knowledge. Theoretical priors from the pedagogical theory node 210 provide formal rules about interval relationships, scale structures, and harmonic progressions that constrain tone selection choices. Experiential priors from the experiential knowledge node 215 incorporate performance practice knowledge including ornamentation conventions, stylistic preferences, and cultural tuning traditions. The context input module 310 dynamically adjusts the relative weights of different prior sources based on musical context and application requirements.

The context input module 310 implements adaptive context window sizing that adjusts the temporal scope of analysis based on musical characteristics and processing requirements. Short context windows within the context input module 310 focus on immediate harmonic relationships and local melodic patterns for applications requiring low latency. Extended context windows within the context input module 310 capture large-scale musical structures including modulation schemes, developmental processes, and formal sectional relationships. The context input module 310 employs overlapping context windows with different temporal scales to capture musical relationships at multiple hierarchical levels simultaneously.

Referring to FIG. 1, the context input module 310 processes different musical scales and modes by analyzing their harmonic relationships as represented in the Tonnetz diagram structure with the vertical power scale 105 and horizontal power scale 110. The context input module 310 identifies scale-specific tone selection patterns by analyzing the geometric relationships between the notes of the scale. Scale recognition within the context input module 310 constrains the set of available pure tone options based on the identified modal framework and its associated harmonic relationships. The context input module 310 adapts tone selection strategies based on the relative importances of each note, melodic patterns and trajectories favored by the piece, as well as ornamentation influences.

Referring to FIG. 1, the Tonnetz diagram illustrates the mathematical relationships between pure tone frequencies through a two-dimensional lattice structure where the vertical power scale 105 represents powers of 5 and the horizontal power scale 110 represents powers of 3. The diagram demonstrates how pure tone frequencies are constructed through combinations of these fundamental harmonic ratios, with each position in the lattice corresponding to a specific frequency ratio relative to a tonic reference frequency. The vertical power scale 105 enables representation of intervals based on the perfect third ratio of 5/4, while the horizontal power scale 110 enables representation of intervals based on the perfect fifth ratio of 3/2. In this context, multiplying or dividing the frequency by 2 or powers of 2 represents mere octave shifts, and are hence ignored in the characterization of notes in the harmonic space.

Adjacent tones positioned horizontally within the Tonnetz diagram have an interval of the fifth between them, corresponding to a frequency ratio of 3/2. This horizontal relationship reflects the natural harmonic series where the fifth appears as the third harmonic relative to the fundamental frequency. Adjacent tones positioned vertically within the diagram have an interval of the third between them, corresponding to a frequency ratio of 5/4. This vertical relationship captures the major third interval that forms the basis for major chord structures and consonant harmonic progressions.

The bhoop scale 115 illustrates a specific selection of pure tone frequencies arranged within the Tonnetz lattice structure that corresponds to a pentatonic scale commonly used in Indian classical music. The deshkar scale 120 illustrates an alternative selection of pure tone frequencies that, while using the same basic pentatonic structure as the bhoop scale 115, employs different specific frequency ratios to create distinct melodic and harmonic characteristics. The intersection scale 125 represents elements present in both the bhoop scale 115 and the deshkar scale 120.

These demonstrate how a particular musical context requires specific pure tone choices that optimize harmonic relationships within that cultural and melodic framework. This contextual variation in pure tone selection represents the core challenge that the system addresses through automated analysis and inference. Different pure tone implementations may be seen depending on the broader musical context, performance style, and cultural framework being employed.

Table 1 illustrates the relationship between equal-tempered frequencies and their corresponding pure tone alternatives through specific mathematical comparisons. Equal-tempered frequencies are expressed as powers of the twelfth root of two, including 2^{1/12} for the equal-tempered semitone, 2^{2/12} for the equal-tempered whole tone, 2^{3/12} for the equal-tempered minor third, 2^{4/12} for the equal-tempered major third, and 2^{7/12} for the equal-tempered perfect fifth. These equal-tempered intervals approximate but do not exactly match the pure tone ratios represented in the Tonnetz lattice structure from FIG. 1.

The corresponding pure tone frequencies are expressed as whole-number ratios that provide exact harmonic relationships between tones. The ratio 16/15 represents a pure semitone interval that differs slightly from the equal-tempered 2^{1/12} approximation. The ratio 25/24 provides an alternative pure semitone that creates different harmonic implications depending on the musical context. The ratios 10/9 and 9/8 represent two different pure whole tone intervals, with 10/9 corresponding to a minor tone and 9/8 corresponding to a major tone in just intonation systems.

Pure tone ratios for third intervals include 6/5 for the minor third, 32/27 for an alternative minor third, 75/64 for another minor third variant, and 5/4 for the major third. The ratio 5/4 represents the pure major third that creates perfect consonance with the tonic, while the equal-tempered 2^{4/12} approximation introduces slight beating and harmonic impurity. Additional pure tone ratios include 81/64 and 32/25, which represent different approaches to constructing the major third interval depending on the harmonic context and voice leading considerations within the musical passage.

The perfect fifth interval demonstrates the difference between equal-tempered and pure tone approaches through the comparison of 2^{7/12} and 3/2. The pure tone ratio 3/2 creates perfect harmonic alignment between the fundamental frequency and its fifth, eliminating the slight beating present in the equal-tempered approximation. The ratio 40/27 represents an alternative fifth interval that creates different harmonic implications in specific musical contexts where the standard 3/2 ratio would conflict with other harmonic requirements.

With continued reference to FIG. 1, the lattice structure of the Tonnetz diagram enables visualization of harmonic progressions and voice leading patterns through geometric relationships between adjacent nodes. Harmonic progressions that move smoothly through the lattice correspond to voice leading patterns that minimize harmonic disruption and maintain consonant relationships between successive chords. The system utilizes these geometric relationships within the learning processor 315 to encode harmonic dependencies and predict appropriate pure tone selections based on the harmonic trajectory of the musical passage.

The Tonnetz diagram structure informs the learning processor 315 architecture through explicit encoding of the harmonic relationships represented by the vertical power scale 105 and horizontal power scale 110. Graph neural networks within the learning processor 315 process the lattice structure as a connectivity graph where edges represent consonant harmonic intervals and nodes represent specific pure tone frequencies. The learning processor 315 may apply belief propagation or graph convolution operations across this harmonic lattice to propagate information between harmonically related tones and update probability estimates for tone selection based on local harmonic context.

The mathematical relationships illustrated in the Tonnetz diagram provide the theoretical foundation for the prime-limit and odd-limit constraints implemented within the learning processor 315. The 5-limit tuning system represented by the diagram restricts pure tone ratios to combinations of powers of 2, 3, and 5, corresponding to the fundamental frequency, perfect fifth, and major third relationships. The learning processor 315 applies these constraints to limit the complexity of pure tone ratios while ensuring that selected frequencies maintain perceptually significant harmonic relationships with surrounding tones.

The context input module 310 utilizes the harmonic relationships demonstrated in the Tonnetz diagram to analyze scale-specific patterns and modal characteristics within musical passages. Scale recognition algorithms within the context input module 310 identify whether a passage employs the bhoop scale 115, deshkar scale 120, or other modal frameworks by analyzing the distribution of tones within the harmonic lattice. The context input module 310 constrains pure tone selection based on the identified scale structure and its associated harmonic implications as represented within the Tonnetz framework.

The inference module 320 applies the harmonic relationships encoded in the Tonnetz diagram structure to generate probability distributions over candidate pure tone selections for each note in the musical passage. The inference module 320 computes harmonic compatibility scores between candidate tones and their surrounding musical context by evaluating the geometric distances and connectivity patterns within the lattice structure. Tones that maintain closer harmonic relationships within the Tonnetz framework receive higher probability assignments from the inference module 320, while tones that create harmonic disruption receive lower probability scores.

Referring to FIG. 2, the network diagram illustrates the relationships between three interacting layers that form the foundation for the system's learning and inference capabilities. The theoretical ground truth node 205 represents the ideal pure tone frequencies that provide mathematically perfect harmonic relationships for any given musical context. The pedagogical theory node 210 represents explicit musical rules and conventions that have been codified through formal music theory, written treatises, and established pedagogical frameworks. The experiential knowledge node 215 represents tacit or experiential knowledge including intonation habits, vocalization techniques, playing techniques, and ornamental practices that musicians develop through practical experience and cultural transmission.

The bidirectional arrows connecting each node to the others illustrate the causal relationships and information flow between these three layers of musical knowledge. The bidirectional arrow between the theoretical ground truth node 205 and the pedagogical theory node 210 represents how theoretical ideals inform the development of formal pedagogical frameworks while explicit musical rules influence the definition of what constitutes ideal pure tone selection. The bidirectional arrow between the theoretical ground truth node 205 and the experiential knowledge node 215 demonstrates how ideal pure tones guide the development of performance practices while practical musical experience refines the understanding of contextually appropriate theoretical ideals.

The bidirectional arrow between the pedagogical theory node 210 and the experiential knowledge node 215 captures the relationship between formal musical education and practical performance experience. Explicit musical rules and conventions shape how musicians develop their intonation habits and playing techniques through structured learning processes. Conversely, the accumulated experiential knowledge of skilled performers influences the evolution and refinement of pedagogical approaches and theoretical frameworks within musical traditions.

The system deduces information about any one layer given partial information from the other layers through statistical inference and pattern recognition algorithms implemented within the learning processor 315. When the system receives information about explicit musical rules from the pedagogical theory node 210 and practical performance data from the experiential knowledge node 215, the learning processor 315 infers the corresponding theoretical ground truth represented by the theoretical ground truth node 205. This inference process enables the system to determine ideal pure tone frequencies even when direct theoretical prescriptions are unavailable or incomplete.

The learning processor 315 utilizes information from the pedagogical theory node 210 and the theoretical ground truth node 205 to infer patterns within the experiential knowledge node 215 when direct performance data is limited. This capability enables the system to predict how skilled musicians would approach pure tone selection in specific musical contexts based on theoretical knowledge and established pedagogical principles. The learning processor 315 applies these inferred patterns to generate appropriate pure tone selections for musical passages that lack direct empirical examples from professional performances.

When the system receives information from the theoretical ground truth node 205 and the experiential knowledge node 215, the learning processor 315 deduces the underlying pedagogical principles represented by the pedagogical theory node 210. This deduction process enables the system to identify implicit rules and conventions that govern pure tone selection within specific musical traditions or cultural contexts. The learning processor 315 extracts these pedagogical patterns and applies them to new musical contexts where similar theoretical and practical considerations apply.

The information flow between the three nodes enables the system to handle incomplete or conflicting information sources through weighted integration schemes implemented within the learning processor 315. When theoretical ideals from the theoretical ground truth node 205 conflict with practical performance conventions from the experiential knowledge node 215, the learning processor 315 resolves these conflicts by considering the pedagogical context provided by the pedagogical theory node 210. The system adjusts the relative weights assigned to each information source based on the musical context, cultural framework, and application requirements.

The learning processor 315 obtains theoretical ground truth knowledge via labels from block 325 and the melodic material both in the pedagogical theory parlance as well as data from performance nuances via the context input block 310.

The learning processor 315 may also incorporate a semi-supervised approach where it refines and updates its own understanding of the correlations between the formal melodic structure (node 210) and manifestations of tacit/experiential knowledge (node 215) on unlabeled data as well.

The learning processor 315 implements cross-validation between the three nodes to ensure consistency and accuracy in pure tone inference. Information derived from any two nodes is validated against the third node to identify potential inconsistencies or errors in the training data. This cross-validation process enables the learning processor 315 to detect and correct biases or inaccuracies that might arise from incomplete or culturally specific training examples.

The network structure enables the system to generalize beyond the specific musical traditions represented in the training data by identifying universal principles that operate across different cultural and stylistic contexts. The learning processor 315 extracts common patterns from the relationships between the theoretical ground truth node 205, pedagogical theory node 210, and experiential knowledge node 215 that apply to multiple musical frameworks. These universal principles enable the system to adapt to new musical styles or cultural contexts by leveraging the fundamental relationships between theoretical ideals, pedagogical approaches, and performance practices.

The system enables inference of appropriate pure tones from melodically structured pieces through the integration of information from all three nodes within the network structure. The theoretical ground truth node 205 provides the mathematical foundation for harmonic relationships and frequency ratios that define pure tone selections. The pedagogical theory node 210 contributes formal rules about scale structures, modal frameworks, and harmonic progressions that constrain the set of appropriate pure tone options. The experiential knowledge node 215 provides practical insights about performance techniques, ornamental practices, and stylistic conventions that influence pure tone selection in specific musical contexts.

The learning processor 315 processes melodically structured pieces by analyzing their harmonic content, melodic patterns, and rhythmic characteristics in relation to the knowledge encoded within the three-node network structure. Melodic analysis within the learning processor 315 identifies scale degrees, intervallic relationships, and motivic patterns that correspond to specific pure tone selection strategies represented within the network. Harmonic analysis correlates chord progressions and voice leading patterns with the theoretical principles encoded in the theoretical ground truth node 205 and the practical approaches represented in the experiential knowledge node 215.

The network structure enables the system to handle cultural specificity in pure tone selection through specialized training on tradition-specific examples while maintaining the ability to generalize across different musical frameworks. The pedagogical theory node 210 encodes culture-specific rules and conventions that govern pure tone selection within particular musical traditions such as Indian classical music, Western classical music, or other regional musical systems. The experiential knowledge node 215 captures performance practices and stylistic preferences that are specific to individual musical cultures while identifying common principles that apply across different traditions.

The learning processor 315 utilizes the network structure to implement adaptive learning algorithms that continuously refine the relationships between the three nodes based on new training data and performance feedback. Adaptive learning within the system enables the theoretical ground truth node 205, pedagogical theory node 210, and experiential knowledge node 215 to evolve and improve their representations as additional musical examples and expert annotations become available. This adaptive capability ensures that the system remains current with evolving musical practices and theoretical developments within different musical traditions.

The information flow between the nodes enables the system to provide explanatory feedback about pure tone selection decisions through traceability back to the underlying theoretical, pedagogical, or experiential justifications. When the inference module 320 generates pure tone predictions, the system traces these decisions back through the network structure to identify which aspects of the theoretical ground truth node 205, pedagogical theory node 210, or experiential knowledge node 215 contributed to the final selection. This traceability enables musicians and music educators to understand the reasoning behind automated pure tone selections and to validate the appropriateness of the system's decisions within their specific musical contexts.

The network structure supports multi-objective optimization within the learning processor 315 where pure tone selections balance competing considerations from the theoretical ground truth node 205, pedagogical theory node 210, and experiential knowledge node 215. Multi-objective optimization enables the system to find pure tone selections that simultaneously satisfy theoretical harmonic ideals, conform to established pedagogical principles, and align with practical performance conventions. The learning processor 315 applies Pareto optimization techniques to identify pure tone selections that represent optimal trade-offs between these potentially conflicting objectives.

The bidirectional information flow enables the system to perform sensitivity analysis to determine how changes in one node affect the relationships with the other nodes and the resulting pure tone selections. Sensitivity analysis within the learning processor 315 evaluates how variations in theoretical ideals, pedagogical approaches, or performance practices influence the overall system behavior and prediction accuracy. This analysis capability enables the system to identify which aspects of musical knowledge have the greatest impact on pure tone selection decisions and to focus learning efforts on the most influential factors.

The network structure enables the system to handle uncertainty and ambiguity in pure tone selection through probabilistic inference algorithms that propagate uncertainty information between the three nodes. When information from any node is incomplete or uncertain, the learning processor 315 propagates this uncertainty through the network structure to generate probability distributions over candidate pure tone selections rather than deterministic choices. This probabilistic approach enables the system to communicate confidence levels in its predictions and to identify situations where additional information or human expertise would improve the accuracy of pure tone selection decisions.

Referring to FIG. 4, the pitch correction process transforms equal-tempered frequencies to natural tuning frequencies through continuous frequency adjustment that operates across different types of musical content. The frequency axis 405 represents fundamental frequency in Hz and provides the vertical scale for measuring the frequency corrections applied by the system. The equal tempered line 410 represents the original equal-tempered pitch that serves as the input to the correction process, while the pure tone line 415 represents the corrected natural tuning frequency that serves as the output of the system processing.

The pitch correction process operates on stable sustained notes by analyzing the steady-state frequency content and applying corrections that shift the fundamental frequency from the equal tempered line 410 to the corresponding position on the pure tone line 415. The system identifies stable sustained notes through spectral analysis that detects regions of consistent fundamental frequency with minimal temporal variation. The correction process for stable notes involves direct frequency shifting where the fundamental frequency is adjusted to match the contextually appropriate pure tone ratio determined by the inference module 320.

The pitch correction process extends beyond stable notes to handle notes that feature as part of pitch oscillations, including vibrato and other periodic frequency modulations. The system analyzes the oscillatory patterns in the input signal and applies corrections that preserve the oscillatory characteristics while shifting the center frequency and oscillation boundaries to align with pure tone relationships. The pure tone line 415 demonstrates how the correction process maintains the temporal dynamics of pitch oscillations while adjusting the frequency content to achieve natural tuning relationships.

Inflection points in glides receive specialized processing within the pitch correction system through analysis of the continuous frequency trajectory and identification of critical transition points where the frequency direction changes. The system applies corrections to glide passages by adjusting the frequency trajectory to follow pure tone relationships while preserving the smooth continuous nature of the glide. The correction process for glides involves interpolation between pure tone targets at the beginning and end of the glide passage, with intermediate frequency values adjusted to maintain smooth transitions through harmonically appropriate frequency paths.

Other embellishments including grace notes, mordents, and trills receive corrections through analysis of their rapid frequency transitions, identification of the points of interest where the frequency needs to be aligned to a tone, and the application of pure tone adjustments at said points, thereby preserving the ornamental character while improving harmonic accuracy. The system identifies embellishment patterns through temporal and spectral analysis that detects rapid frequency changes with specific rhythmic and melodic characteristics. The correction process for embellishments applies pure tone adjustments to each component of the ornamental figure while maintaining the timing and relative frequency relationships that define the embellishment type.

The identification of stable notes, key points of interest in glides, mordents, and other embellishments, etc. may be aided by a separate learnt module using labelled tagging data, or any statistical or rule-based classification method.

The pitch correction process applies corrections to specific overtones within a complex spectrum through harmonic analysis that identifies individual frequency components and their relationships to the fundamental frequency. The system performs spectral decomposition of complex tones to isolate individual harmonic components and applies frequency corrections to each overtone based on its harmonic relationship to the corrected fundamental frequency. Overtone corrections ensure that the entire harmonic spectrum maintains pure tone relationships rather than only correcting the fundamental frequency component.

Harmonic correction within complex spectra involves analysis of the overtone series and adjustment of individual harmonic frequencies to maintain integer ratio relationships with the corrected fundamental frequency. The system identifies overtones through peak detection in the frequency domain and calculates the appropriate pure tone frequencies for each harmonic component based on the harmonic series relationships. The correction process adjusts each overtone frequency to align with the theoretical harmonic series while preserving the relative amplitude relationships that define the timbral characteristics of the sound.

The spectral correction process handles inharmonic content within complex tones through analysis that distinguishes between harmonic overtones that should follow pure tone relationships and inharmonic components that represent noise, formants, or other spectral characteristics that should be preserved without frequency correction. The system applies selective frequency correction that adjusts harmonic components while leaving inharmonic content unchanged to maintain the natural timbral characteristics of the original sound source.

The accurate identification of harmonic content to by corrected may also be aided by statistical learning methods.

With continued reference to FIG. 4, the temporal evolution of the pitch correction process demonstrates how the pure tone line 415 converges toward the equal tempered line 410 over time, illustrating the dynamic nature of the correction process as it responds to changing musical context. The convergence pattern reflects how the system adapts its correction strategy based on the evolving harmonic and melodic context provided by the context input module 310. The temporal dynamics of the correction process enable the system to provide smooth transitions between different pure tone selections as the musical context changes.

The generation of the corrected signal output 330 occurs through multiple processing pathways that produce audio form, symbolic form, or both formats depending on the application requirements and user specifications. Audio form generation involves synthesis of the corrected frequency content into time-domain waveforms that can be played back through standard audio equipment. The audio synthesis process reconstructs the corrected signal by combining the frequency-corrected fundamental and overtone components with the preserved timbral characteristics and temporal envelope information from the original input signal.

Symbolic form generation within the corrected signal output 330 produces discrete musical notation that specifies the corrected pure tone frequencies for each note in the musical passage. The symbolic output includes note names, frequency ratios, timing information, and other musical parameters that enable the corrected tuning information to be used in music notation software, digital audio workstations, or other symbolic music processing applications. The symbolic representation preserves the discrete note structure while incorporating the continuous frequency corrections determined by the pitch correction process.

Dual format generation enables the corrected signal output 330 to provide both audio and symbolic representations simultaneously, allowing applications that require both playback capability and notation editing functionality. The system maintains synchronization between the audio and symbolic representations to ensure consistency between the audible output and the notated frequency specifications. Dual format output enables comprehensive music production workflows that integrate both performance and composition aspects of the corrected musical content.

Postprocessing operations applied to the corrected signal output 330 include dynamic range adjustment, spectral shaping, and temporal smoothing that optimize the corrected audio for specific playback systems or application requirements. Dynamic range processing adjusts the amplitude relationships between different frequency components to maintain balanced spectral content after frequency correction. Spectral shaping applies filtering operations that enhance the harmonic clarity of the corrected pure tones while reducing artifacts that might arise from the frequency correction process.

Temporal smoothing within the postprocessing stage reduces discontinuities that might occur at the boundaries between different pure tone selections or during rapid frequency transitions. The smoothing process applies interpolation algorithms that create smooth frequency transitions while preserving the accuracy of the pure tone relationships. The interpolation also ensures fidelity to the original signal by mimicking the transitions between the tones as done there. Temporal smoothing ensures that the corrected signal output 330 maintains natural-sounding frequency evolution without introducing audible artifacts from the correction process.

Referring to FIG. 3, the corrected signal output 330 integrates the processing results from both the learning processor 315 and the inference module 320 to generate the final output in the specified format. The integration process combines the learned patterns from the learning processor 315 with the contextual predictions from the inference module 320 to determine the specific frequency corrections applied to each component of the input signal. The corrected signal output 330 reflects the complete processing pipeline from context analysis through pattern recognition to final frequency correction and format conversion.

Format conversion within the corrected signal output 330 utilizes the mapping functions that convert between audio and symbolic representations as defined in the mathematical formulation of the system. The audio-to-symbolic mapping enables the system to generate notation-based output from corrected audio signals, while the symbolic-to-audio mapping enables synthesis of corrected audio from symbolic input. These bidirectional mapping capabilities ensure that the corrected signal output 330 can be generated in the appropriate format regardless of the input format or processing pathway used.

Quality control processing within the corrected signal output 330 validates the frequency corrections against the harmonic relationships encoded in the learning processor 315 and the contextual constraints provided by the context input module 310. The validation process checks that the corrected frequencies maintain appropriate harmonic ratios, fall within the specified prime-limit or odd-limit constraints, and align with the cultural and stylistic preferences encoded in the training data. Quality control ensures that the corrected signal output 330 meets the accuracy and consistency requirements for the intended application.

Real-time generation of the corrected signal output 330 enables live performance applications where the frequency corrections are applied with minimal latency during musical performance. Real-time processing utilizes causal temporal dependence within the context input module 310 to generate corrections based on past musical context without requiring future information. The real-time processing pathway optimizes computational efficiency to maintain low latency while preserving the accuracy of the pure tone corrections.

Batch processing generation of the corrected signal output 330 enables post-production applications where the complete musical passage is available for analysis and correction. Batch processing utilizes bidirectional temporal dependence within the context input module 310 to optimize corrections based on the complete musical context including future information. The batch processing pathway prioritizes correction accuracy over processing speed and enables more sophisticated analysis of long-range musical relationships and global harmonic optimization.

Multi-track generation within the corrected signal output 330 handles simultaneous processing of multiple musical parts while maintaining harmonic consistency across all tracks. The system coordinates the frequency corrections applied to different tracks to ensure that harmonic relationships between simultaneous notes remain consonant after correction. Multi-track processing requires cross-track analysis within the context input module 310 and coordinated inference across multiple musical lines within the inference module 320.

The corrected signal output 330 incorporates metadata that documents the specific corrections applied to each component of the musical signal, including the original frequencies, corrected frequencies, frequency ratios, and contextual justifications for each correction decision. Metadata documentation enables users to understand and validate the corrections applied by the system and provides traceability back to the theoretical, pedagogical, or experiential knowledge sources that informed each correction decision. The metadata also enables manual adjustment or refinement of the corrections based on user preferences or specific performance requirements.

Error handling within the corrected signal output 330 addresses situations where the pitch correction process encounters ambiguous or conflicting information from the context input module 310 or uncertain predictions from the inference module 320. The error handling process applies fallback strategies that prioritize harmonic stability and musical coherence when optimal pure tone selections cannot be determined with high confidence. Error handling ensures that the corrected signal output 330 maintains musical quality even when the input signal contains challenging or ambiguous content that exceeds the system's training data coverage.

Adaptive output formatting within the corrected signal output 330 adjusts the output characteristics based on the intended application and playback system requirements. The system adapts sample rates, bit depths, frequency ranges, and other technical parameters to match the specifications of the target application or hardware system. Adaptive formatting ensures compatibility between the corrected signal output 330 and downstream processing systems while preserving the accuracy of the pure tone corrections across different technical platforms and playback environments.

The system is implemented in hardware configurations where physical resonating elements respond to acoustic input (such as past overtone content) and have certain modes excited that mechanically bias vibrations toward consonant ratios and thereby automatically adjusting their vibrational characteristics to produce pure tone frequencies. Hardware implementations utilize strings, membranes, or other vibrational elements that possess multiple resonant modes and can be dynamically controlled through mechanical, electromagnetic, or piezoelectric actuation systems. The hardware implementation receives control signals from the inference module 320 that specify the target pure tone frequencies and timing for mechanical adjustments based on the contextual analysis performed by the context input module 310 and pattern recognition executed by the learning processor 315.

Referring to FIG. 3, the inference module 320 generates control logic signals that drive physical actuators within the hardware implementation to perform real-time tuning adjustments. The control logic translates the pure tone frequency predictions into mechanical adjustment commands that modify the tension, length, or boundary conditions of resonating elements. The hardware implementation receives these control signals through digital-to-analog converters that transform the symbolic frequency specifications into analog voltage or current signals suitable for driving mechanical actuators.

String-based hardware implementations utilize tensioning mechanisms that adjust string tension in response to control signals from the inference module 320 to shift the fundamental resonant frequency toward the target pure tone frequency. The tensioning mechanisms include servo motors, stepper motors, or linear actuators that modify string tension through mechanical linkages connected to tuning pegs or bridge adjustments. String tension adjustments occur rapidly enough to accommodate real-time performance requirements while maintaining sufficient precision to achieve the frequency accuracy specified by the pure tone calculations.

The string-based hardware responds to past overtone content by analyzing the harmonic spectrum of previously played notes and exciting specific string modes that create sympathetic resonance with the target pure tone frequencies. Sympathetic resonance occurs when the string's natural resonant modes align with the harmonic content of the acoustic environment, creating reinforcement of specific frequency components. The hardware implementation monitors the acoustic environment through microphones or contact sensors that detect the overtone content from time steps before the current time and uses this information to pre-condition the string resonance characteristics.

Membrane-based hardware implementations utilize drumhead or diaphragm structures with variable tension or boundary condition control systems that adjust the membrane's resonant characteristics. The membrane tension control systems include circumferential tensioning rings, radial tensioning mechanisms, or localized pressure application systems that modify the membrane's vibrational modes. Membrane-based implementations respond to past overtone content by analyzing the spectral characteristics of previous acoustic input and adjusting membrane tension to emphasize resonant modes that align with the target pure tone frequencies.

The membrane hardware creates mechanical bias toward consonant ratios through selective excitation of vibrational modes that correspond to harmonic relationships encoded in the learning processor 315. Mode-selective excitation utilizes multiple actuators positioned at specific locations on the membrane surface to preferentially excite modes with frequency relationships that match the pure tone ratios determined by the system analysis. The actuator positioning corresponds to the nodal patterns of the desired vibrational modes, enabling efficient energy transfer into the target resonant frequencies while suppressing unwanted modes.

Electromagnetic actuation systems within the hardware implementation utilize magnetic field control to influence the vibrational characteristics of ferromagnetic strings or membranes. Electromagnetic actuators include solenoids, voice coils, or magnetic field gradient generators that apply forces to the resonating elements without direct mechanical contact. The electromagnetic control systems receive analog control signals from the inference module 320 and generate magnetic fields with temporal and spatial characteristics that bias the vibrational motion toward the target pure tone frequencies.

Piezoelectric actuation systems within the hardware implementation utilize piezoelectric transducers attached to or embedded within the resonating elements to apply controlled mechanical forces that modify the vibrational characteristics. Piezoelectric actuators respond rapidly to electrical control signals and provide precise force control with minimal mechanical complexity. The piezoelectric control systems apply forces at specific locations and with specific temporal patterns that excite the desired vibrational modes while suppressing modes that would produce equal-tempered or other non-pure-tone frequencies.

With continued reference to FIG. 3, the hardware implementation integrates sensor feedback systems that monitor the actual vibrational characteristics of the resonating elements and provide closed-loop control to ensure accurate pure tone frequency production. Sensor systems include accelerometers, strain gauges, optical displacement sensors, or acoustic microphones that detect the actual frequency content produced by the hardware. The sensor feedback enables the control system to compensate for mechanical variations, temperature effects, or other factors that might cause deviations from the target pure tone frequencies.

The hardware control system implements predictive algorithms that anticipate the required mechanical adjustments based on the musical context analysis performed by the context input module 310. Predictive control utilizes the temporal dependence information to begin mechanical adjustments before the target notes are actually played, reducing the response time and enabling seamless real-time performance. The predictive algorithms analyze the causal temporal relationships to determine when specific pure tone frequencies will be needed and initiate the corresponding mechanical adjustments with appropriate lead time.

Referring to FIG. 4, the hardware implementation produces frequency corrections that follow the pure tone line 415 through mechanical adjustment of the resonating element characteristics rather than through digital signal processing. The mechanical frequency correction occurs through continuous adjustment of the physical parameters that determine the resonant frequencies of the strings or membranes. The hardware produces smooth frequency transitions that match the temporal evolution shown by the pure tone line 415 while maintaining the natural acoustic characteristics of the physical resonating elements.

Multi-mode excitation within the hardware implementation utilizes multiple actuators or control systems that simultaneously influence different vibrational modes of the resonating elements. Multi-mode control enables the hardware to produce complex harmonic content where individual overtones are adjusted to maintain pure tone relationships with the fundamental frequency. The multi-mode excitation systems coordinate the control of fundamental and overtone frequencies to ensure that the entire harmonic spectrum maintains the mathematical relationships specified by the pure tone calculations.

The hardware implementation incorporates mechanical coupling between multiple resonating elements to create sympathetic resonance effects that reinforce the pure tone frequency relationships. Mechanical coupling utilizes shared mounting structures, acoustic coupling chambers, or direct mechanical linkages that enable energy transfer between different resonating elements. The coupling mechanisms create natural reinforcement of consonant frequency relationships while suppressing dissonant combinations, providing passive mechanical bias toward pure tone harmonic structures.

Referring to FIG. 1, the hardware implementation utilizes the harmonic relationships represented by the vertical power scale 105 and horizontal power scale 110 to determine the mechanical coupling characteristics between different resonating elements. The coupling strength between elements is proportional to the harmonic consonance of their frequency relationships as represented in the Tonnetz diagram structure. Elements tuned to frequencies corresponding to the bhoop scale 115, versus the deshkar scale 120, receive stronger mechanical coupling depending on the melodic patterns played, to reinforce the scale-specific harmonic relationships.

Adaptive mechanical systems within the hardware implementation adjust their coupling characteristics based on the scale identification and modal analysis performed by the context input module 310. The adaptive coupling systems utilize variable mechanical linkages, adjustable acoustic chambers, or electronically controlled coupling elements that modify the strength and frequency selectivity of the coupling between resonating elements. Adaptive coupling enables the hardware to optimize its mechanical response for different musical scales and cultural tuning preferences encoded in the learning processor 315.

The hardware implementation includes mechanical memory systems that retain information about past overtone content through persistent mechanical states or stored energy configurations. Mechanical memory utilizes spring systems, mechanical latches, or bistable mechanical elements that maintain specific configurations corresponding to previous acoustic input. The mechanical memory systems enable the hardware to respond to past overtone content by maintaining mechanical bias states that influence the current vibrational characteristics based on the harmonic history of the acoustic environment.

Referring to FIG. 2, the hardware implementation integrates the knowledge relationships represented by the theoretical ground truth node 205, pedagogical theory node 210, and experiential knowledge node 215 through mechanical design parameters that embody these different aspects of musical knowledge. The mechanical design incorporates theoretical harmonic relationships through precise frequency ratio implementations, pedagogical principles through standardized mechanical interfaces, and experiential knowledge through mechanical characteristics that emulate the response of traditional acoustic instruments.

Real-time mechanical adjustment within the hardware implementation occurs with response times compatible with musical performance requirements, typically within milliseconds of receiving control signals from the inference module 320. The mechanical response time is achieved through lightweight actuator systems, high-bandwidth control electronics, and mechanical designs that minimize inertia and maximize actuation efficiency. Real-time adjustment enables the hardware to track rapid musical passages and ornamental elements while maintaining accurate pure tone frequency relationships.

The hardware implementation produces acoustic output that directly generates pure tone frequencies through mechanical resonance rather than requiring subsequent digital processing or correction. Direct acoustic generation eliminates the latency and artifacts associated with digital signal processing while providing the natural acoustic characteristics of physical resonating elements. The mechanical pure tone generation creates acoustic output with harmonic content and temporal evolution that matches the natural behavior of traditional acoustic instruments while achieving the frequency accuracy of pure tone mathematical relationships.

Calibration systems within the hardware implementation utilize reference frequency sources and automated adjustment procedures to maintain accurate pure tone frequency relationships over time and environmental conditions. Calibration procedures include automated tuning sequences that adjust the mechanical parameters to match reference pure tone frequencies, temperature compensation algorithms that account for thermal effects on mechanical properties, and periodic recalibration routines that maintain long-term frequency accuracy. The calibration systems ensure that the hardware implementation maintains the precision required for perceptually significant pure tone corrections across varying operating conditions.

The hardware implementation integrates with the software components of the system through standardized communication interfaces that enable real-time exchange of control information and sensor feedback. Communication interfaces include MIDI protocols for musical control information, audio interfaces for acoustic monitoring, and custom digital protocols for high-resolution frequency control data. The integration enables the hardware implementation to function as a controlled acoustic output device within the complete system architecture while maintaining compatibility with standard musical equipment and software environments.

Modular hardware designs enable the implementation to be configured for different musical applications through interchangeable resonating elements, actuator systems, and control electronics. Modular configurations include string-based modules for melodic instruments, membrane-based modules for percussive applications, and hybrid modules that combine multiple resonating element types. The modular approach enables the hardware implementation to be adapted for different musical styles, cultural tuning preferences, and performance requirements while utilizing common control logic and interface systems derived from the inference module 320.

A number of implementations have been described. Nevertheless, it will be understood that various modifications may be made without departing from the spirit and scope of the disclosure. Accordingly, other implementations are within the scope of the following claims.

The system can further be described as a system for automatic conversion of musical pieces to natural tuning based on contextual analysis, comprising:
a. a context input module configured to receive musical context information from at least one musical track, wherein the musical context information comprises at least one of note distribution over time, melodic motifs, harmonic content, temporal dependencies, metadata, and accompanying instrument data;
b. a learning processor configured to process the musical context information using at least one of statistical models and rule-based models to identify patterns linking the musical context information with natural tuning relationships, wherein the learning processor incorporates harmonic relationships between tones as dependencies and operates under a predetermined prime-limit that constrains numerical complexity of natural tuning frequency ratios; and
c. an inference module operatively connected to the context input module and the learning processor, wherein the inference module is configured to convert input notes from equal-tempered tuning to corresponding natural tuning frequencies based on the identified patterns and the musical context information, wherein the inference module generates output comprising natural tuning frequencies for each input note, and wherein each natural tuning frequency corresponds to frequency ratios expressed as whole number relationships.

The system of current disclosure, wherein the context input module is configured to process the musical context information in real-time for live performance applications.

The system of current disclosure, wherein the context input module is configured to process the musical context information in batch mode for recorded material processing.

The system of current disclosure, wherein the inference module utilizes bidirectional temporal information to refine natural tuning frequency estimates.

The system of current disclosure, wherein the bidirectional temporal information includes both preceding and succeeding musical context to influence tone selection at any given time point.

The system of current disclosure, further comprising an audio processing module configured to convert between audio signals and symbolic musical representations.

The system of current disclosure, wherein the audio processing module includes mapping functions that convert audio signals to symbolic space and symbolic space to audio signals.

The system of current disclosure, wherein the inference module generates probability distributions over candidate natural tuning frequencies for each input note.

The system of current disclosure, wherein the statistical models comprise at least one of neural networks, decision trees, graph embeddings, transformer architectures, semi-supervised methods, and sequence-to-sequence models.

The system of current disclosure, wherein the graph embeddings represent tones as vectors in a continuous space where harmonic relationships correspond to geometric relationships between vectors.

A method for automatic conversion of musical pieces to natural tuning, comprising:
a. receiving musical input data comprising notes in equal-tempered tuning from at least one musical track;
b. analyzing musical context information associated with the musical input data, wherein the musical context information comprises at least one of melodic patterns, harmonic relationships, temporal sequences, and cultural musical characteristics;
c. applying a trained model to the musical context information to determine contextually appropriate natural tuning frequencies for each note in the musical input data, wherein the trained model incorporates harmonic dependencies between tones and operates under prime-limit constraints that restrict frequency ratios to whole number relationships; and
d. generating corrected musical output where each note is converted from equal-tempered tuning to its corresponding natural tuning frequency based on the determined contextually appropriate frequencies.

The method of current disclosure, wherein the step of applying the trained model comprises using machine learning techniques trained on ground truth data comprising at least one of theoretical musical prescriptions and empirical data derived from professional musical performances.

The method of current disclosure, wherein the empirical data is generated through spectral analysis of professionally recorded performances to extract pure tone frequencies.

The method of current disclosure, wherein the step of analyzing musical context information comprises evaluating consonance relationships between simultaneous or successive notes.

The method of current disclosure, wherein the consonance relationships are determined based on frequency ratios that correspond to simple integer relationships between the notes.

A hardware system for producing natural tuning frequencies, comprising:
a. a plurality of resonating elements configured to vibrate at controllable frequencies;
b. a plurality of actuators operatively coupled to the resonating elements, wherein the actuators are configured to adjust vibrational characteristics of the resonating elements in response to control signals;
c. a control system configured to receive musical context information and generate the control signals based on analysis of the musical context information, wherein the control system determines target natural tuning frequencies corresponding to whole number frequency ratios; and
d. wherein the actuators respond to past overtone content by exciting specific modes of the resonating elements that mechanically bias vibrations toward consonant ratios determined by the control system.

The hardware system of current disclosure, wherein the resonating elements comprise strings with variable tension control mechanisms that adjust string tension to shift fundamental resonant frequencies toward the target natural tuning frequencies.

The hardware system of current disclosure wherein the variable tension control mechanisms comprise servo motors operatively connected to tuning pegs through mechanical linkages.

The hardware system of current disclosure, wherein the actuators comprise electromagnetic actuators that apply magnetic forces to ferromagnetic resonating elements without direct mechanical contact.

The hardware system of current disclosure, wherein the electromagnetic actuators generate magnetic fields with temporal and spatial characteristics that selectively excite vibrational modes corresponding to the target natural tuning frequencies while suppressing modes that would produce equal-tempered frequencies.

Referring now to the drawings FIG. 1-4, and more particularly to FIG. 1, there is shown a Tonnetz diagram of Different Tone choices used in different musical contexts for the same notated notes. Wherein Item 105 is the scale for the vertical axis, which denotes powers of 5, Item 110 is the scale for the horizontal axis, which denotes power of 3, Item 115 features exclusively in the Bhoop scale, Item 120 features exclusively in the Deshkar scale, Item 125 occurs in both.

FIG. 2 shows the causal links among three interacting layers Item 210 is the pedagogical theory (explicit musical rules and conventions), Item 215 is the tacit or experiential knowledge (intonation habits, vocalization or playing techniques, ornamentations, etc.), and Item 205 is the theoretical ground truth of ideal pure tones.

FIG. 3 depicts a system diagram showing information flow between a context input module, learning processor, and inference module, according to aspects of the present disclosure. describes the System Diagram and the flow of information across the various components of this invention. Wherein Item 310 describes the possible forms of “context” that can serve as input to the algorithm Any subset of these inputs may be used, depending on the application. These are:

Musical Context:
a. Long-range (note distribution and emphasis over time)
b. Medium/Short-range (melodic motifs, chords, ornamentation such as glides or vibrato, timbre)
c. Temporal dependence-Causal (for real-time inference) or Bidirectional (for dependence on the entire piece/future time steps)
d. Other metadata (lyrics, scale, mood, etc.)
e. Other accompanying instruments/tracks/vocals
f. Representations as raw signal features, symbolic transcripts, or as neural embeddings.

Item 315 is the Learning Module find patterns (either statistically or in a rule-based way) linking this context with ground truth labelled data. These are:

Learning Module:

A statistical OR rule-based model (e.g., a Neural Network/Decision Tree, etc.)
a. Incorporates harmonic relationships between tones as dependencies.
b. Operates under a certain prime-limit/odd-limit that caps the tones' numerical complexities.

Item 320 is the Inference module; this module predicts or assigns probabilities to candidate pure tone choices for each note. These predictions can remain in symbolic form for downstream editing or analysis or be converted into the audio space as the application necessitates. The Inference Module: Maps predictions to either the symbolic space, spectral space, or full audio signals

Item 320 Corrected Signal:

Final output in audio and/or symbolic form, optionally with postprocessing

Item 325 Ground Truth:

Any combination of:
a. Theoretical ideals (tradition-specific prescription)
b. Empirical targets (derived from signal analyses of audio by professionals)
c. Inferred listener preferences (in existing tracks/performances, or via intervention for experimentation)

FIG. 4 shows Pitch Correction for stable notes as well as intermediate notes in oscillations, glides, etc. Wherein Item 405 is the vertical axis and is the fundamental frequency in Hz. Item 410 is Eq. Tempered and Item 415 is Pure tones.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments; it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

I claim:

1. A system for automatic conversion of musical pieces to natural tuning based on contextual analysis, comprising:
a context input module configured to receive musical context information from at least one musical track, wherein the musical context information comprises at least one of note distribution over time, melodic motifs, harmonic content, temporal dependencies, metadata, and accompanying instrument data;
a learning processor configured to process the musical context information using at least one of statistical models and rule-based models to identify patterns linking the musical context information with natural tuning relationships, wherein the learning processor incorporates harmonic relationships between tones as dependencies and operates under a predetermined prime-limit that constrains numerical complexity of natural tuning frequency ratios; and
an inference module operatively connected to the context input module and the learning processor, wherein the inference module is configured to convert input notes from equal-tempered tuning to corresponding natural tuning frequencies based on the identified patterns and the musical context information, wherein the inference module generates output comprising natural tuning frequencies for each input note, and wherein each natural tuning frequency corresponds to frequency ratios expressed as whole number relationships.

2. The system of claim 1, wherein the context input module is configured to process the musical context information in real-time for live performance applications.

3. The system of claim 1, wherein the context input module is configured to process the musical context information in batch mode for recorded material processing.

4. The system of claim 1, wherein the inference module utilizes bidirectional temporal information to refine natural tuning frequency estimates.

5. The system of claim 4, wherein the bidirectional temporal information includes both preceding and succeeding musical context to influence tone selection at any given time point.

6. The system of claim 1, further comprising an audio processing module configured to convert between audio signals and symbolic musical representations.

7. The system of claim 6, wherein the audio processing module includes mapping functions that convert audio signals to symbolic space and symbolic space to audio signals.

8. The system of claim 1, wherein the inference module generates probability distributions over candidate natural tuning frequencies for each input note.

9. The system of claim 1, wherein the statistical models comprise at least one of neural networks, decision trees, graph embeddings, transformer architectures, semi-supervised methods, and sequence-to-sequence models.

10. The system of claim 9, wherein the graph embeddings represent tones as vectors in a continuous space where harmonic relationships correspond to geometric relationships between vectors.

11. A method for automatic conversion of musical pieces to natural tuning, comprising:
receiving musical input data comprising notes in equal-tempered tuning from at least one musical track;
analyzing musical context information associated with the musical input data, wherein the musical context information comprises at least one of melodic patterns, harmonic relationships, temporal sequences, and cultural musical characteristics;
applying a trained model to the musical context information to determine contextually appropriate natural tuning frequencies for each note in the musical input data, wherein the trained model incorporates harmonic dependencies between tones and operates under prime-limit constraints that restrict frequency ratios to whole number relationships; and
generating corrected musical output where each note is converted from equal-tempered tuning to its corresponding natural tuning frequency based on the determined contextually appropriate frequencies.

12. The method of claim 11, wherein the step of applying the trained model comprises using machine learning techniques trained on ground truth data comprising at least one of theoretical musical prescriptions and empirical data derived from professional musical performances.

13. The method of claim 12, wherein the empirical data is generated through spectral analysis of professionally recorded performances to extract pure tone frequencies.

14. The method of claim 11, wherein the step of analyzing musical context information comprises evaluating consonance relationships between simultaneous or successive notes.

15. The method of claim 14, wherein the consonance relationships are determined based on frequency ratios that correspond to simple integer relationships between the notes.

16. A hardware system for producing natural tuning frequencies, comprising:
a plurality of resonating elements configured to vibrate at controllable frequencies;
a plurality of actuators operatively coupled to the resonating elements, wherein the actuators are configured to adjust vibrational characteristics of the resonating elements in response to control signals;
a control system configured to receive musical context information and generate the control signals based on analysis of the musical context information, wherein the control system determines target natural tuning frequencies corresponding to whole number frequency ratios; and
wherein the actuators respond to past overtone content by exciting specific modes of the resonating elements that mechanically bias vibrations toward consonant ratios determined by the control system.

17. The hardware system of claim 16, wherein the resonating elements comprise strings with variable tension control mechanisms that adjust string tension to shift fundamental resonant frequencies toward the target natural tuning frequencies.

18. The hardware system of claim 17, wherein the variable tension control mechanisms comprise servo motors operatively connected to tuning pegs through mechanical linkages.

19. The hardware system of claim 16, wherein the actuators comprise electromagnetic actuators that apply magnetic forces to ferromagnetic resonating elements without direct mechanical contact.

20. The hardware system of claim 19, wherein the electromagnetic actuators generate magnetic fields with temporal and spatial characteristics that selectively excite vibrational modes corresponding to the target natural tuning frequencies while suppressing modes that would produce equal-tempered frequencies.
